(19) United States
(12) Patent Application Publication
(10) Pub. No.: US 2026/0034503 A1
(43) Pub. Date: Feb. 5, 2026

(54) COMPACT COUNTERCURRENT AND COCURRENT ABSORBER DESIGN FOR MOBILE CARBON CAPTURE

(71) Applicant: SAUDI ARABIAN OIL COMPANY, Dhahran (SA)

(72) Inventors: Tianyu Gao, Beaverton, OR (US); Alexander Voice, Novi, MI (US); Esam Z. Hamad, Brighton, MI (US)

(73) Assignee: ARAMCO SERVICES COMPANY, Houston, TX (US)

(21) Appl. No.: 18/789,782

(22) Filed: Jul. 31, 2024

(51) Int. Cl. B01D 53/18; B01D 53/14; B01D 53/34; B01D 53/62; B01D 53/78; B01D 53/92; B01D 53/96

(52) U.S. Cl. CPC B01D 53/185; B01D 53/1412; B01D 53/1425; B01D 53/1475; B01D 53/346; B01D 53/62; B01D 53/78; B01D 53/92; B01D 53/96; B01D 2252/204; B01D 2257/504; B01D 2258/01; B01D 2259/4566

(57) ABSTRACT

An absorber vessel having a first flow section including a gas inlet, a gas distributor, a liquid sump, a level control valve, a packing section, a solvent inlet, a solvent distributor, and a solvent outlet; a second flow section including a second solvent inlet, a second solvent distributor, a second packing section, a gas outlet, a second liquid sump, a second level control valve, a second solvent outlet, and a solvent pump; a divider that divides the first flow section and the second flow section; and a vapor space configured for fluidly connecting the first flow section and the second flow section.

### FIELD OF THE DISCLOSURE

Embodiments of the present disclosure generally relate to systems, apparatuses, and methods for the separation of a carbon dioxide from a fluid stream.

### BACKGROUND

The removal of carbon dioxide (CO₂) and other greenhouse gases from emitting streams in the oil and gas and petrochemicals industries has been an extensively practiced technology. Many operators in the oil and gas and petrochemicals industries have set goals for zero emissions. Processes have been devised to remove carbon dioxide from exhaust streams. Aqueous amine is one of the most common chemicals for absorption of acid gasses such as carbon dioxide. Additionally, a common configuration is to inject exhaust or flue gas at the bottom of a countercurrent absorber and let the gas form a film on the packing surface. As the exhaust or flue gas travels up, the exhaust or flue gas contacts an aqueous amine solvent injected at the top of the countercurrent absorber and is transferred by an exothermal chemical reaction to the liquid phase upon contact at the liquid-gas interface. The aqueous amine stream, enriched with carbon dioxide, then flows out the bottom of the countercurrent absorber and is passed through a stripping column to remove the carbon dioxide, thereby making the amine solution lean prior to reintroduction into the countercurrent absorber.

### SUMMARY OF THE CLAIMED EMBODIMENTS

In one aspect, embodiments disclosed herein relate to an absorber vessel having: a first flow section including: a gas inlet, a gas distributor disposed proximate a bottom of the first flow section and fluidly connected to the gas inlet, a liquid sump disposed below the gas distributor, a level control valve disposed below the gas distributor, a packing section disposed above the gas distributor, a solvent inlet, a solvent distributor disposed proximate a top of the first flow section and fluidly connected to the solvent inlet, and a solvent outlet fluidly connected to the liquid sump; a second flow section including: a second solvent inlet, a second solvent distributor disposed proximate a top of the second flow section and fluidly connected to the second solvent inlet, a second packing section disposed below the second solvent distributor, a gas outlet, a second liquid sump disposed below the second packing section, a second level control valve disposed below the second packing section, a second solvent outlet connected to the second liquid sump, and a solvent pump fluidly connected to the second solvent outlet; a divider that divides the first flow section and the second flow section; and a vapor space configured for fluidly connecting the first flow section and the second flow section.

In another aspect, embodiments disclosed herein relate to a system for reducing emissions from a combustion engine, the system having: a first flow section including: an exhaust stream fluidly connected to a gas distributor, wherein the gas distributor is configured to provide the exhaust stream to the first flow section in an upwards direction; a semi-lean aqueous amine solvent fluidly connected to a solvent distributor, a semi-lean aqueous amine solvent introduced to a top of the first flow section, where the semi-lean aqueous amine solvent is in countercurrent contact with the exhaust stream in a packing section disposed between the gas distributor and a solvent inlet, thereby producing a rich aqueous amine solvent and a partially sweetened exhaust stream; and a liquid sump disposed below the gas distributor including a level control valve; a second flow section further including: a partially sweetened exhaust stream fluidly connected to the first flow section; a lean aqueous amine solvent fluidly connected to a second solvent distributor, the lean aqueous amine solvent introduced to a top of the second flow section, where the lean aqueous amine solvent is in cocurrent contact with the partially sweetened exhaust stream in a second packing section disposed between the second solvent distributor and a gas outlet, thereby producing a semi-lean aqueous amine solvent and a fully sweetened exhaust stream configured to collect a fully sweetened exhaust stream; and a second liquid sump disposed below the second packing section including a second level control valve disposed below the second packing section; a solvent delivery system further including: a semi-lean solvent line fluidly connecting the second liquid sump and the top of the first flow section; a solvent pump configured for pumping the semi-lean aqueous amine solvent from the second liquid sump to the top of the first flow section disposed within the semi-lean solvent line; and a heat exchanger configured for cooling the semi-lean aqueous amine solvent disposed within solvent line.

Other aspects and advantages will be apparent from the following description and the appended claims.

### BRIEF DESCRIPTION OF DRAWINGS

FIG. 1 illustrates a system and apparatus of the compact countercurrent and cocurrent absorber vessel wherein the first flow section (countercurrent flow section) precedes the second flow section (cocurrent flow section), according to one or more embodiments disclosed herein.

FIG. 2 illustrates a system and apparatus of the compact countercurrent and cocurrent absorber vessel wherein the second flow section (cocurrent flow section) precedes the first flow section (countercurrent flow section), according to one or more embodiments disclosed herein.

FIG. 3 illustrates a method reducing emissions by contacting exhaust with an aqueous amine solvent in a compact countercurrent and cocurrent absorber vessel according to one or more embodiments disclosed herein.

FIG. 4 illustrates a four-stage diagram wherein multiple first flow sections (countercurrent flow sections) and multiple second flow sections (cocurrent flow sections) are integrated into a single vessel.

### DETAILED DESCRIPTION

One possible carbon dioxide (CO₂) emission point includes mobile sources such as vehicles and ships. The conventional absorption and stripping process, while fitting for spacious onshore locations, is less feasible in the tight quarters of various shipping or mobile operations. For mobile carbon capture processes installed in locations with limited space available, a more compact absorber is required.

“Compact countercurrent and cocurrent absorber vessel” refers to a vessel that comprises a countercurrent flow section, and a cocurrent flow section divided by a curtain wherein the sections are volumetrically common and equalized in static pressure. Hereinafter, the compact countercurrent and cocurrent absorber vessel will simply be referred to as an “absorber vessel” or a “vessel.” Hereinafter, the countercurrent flow section will be referred to as the “first flow section” and the cocurrent flow section will be referred to as the “second flow section.”

The “first flow section”, e.g. countercurrent flow section, refers to a section of the absorber vessel which includes a gas inlet, a gas distributor, a liquid sump, a level control valve, a packing section, and a solvent distributor, a solvent inlet, and a solvent outlet fluidly connected to the liquid sump. The first flow section receives a stream of exhaust gas, an exhaust stream, and a separate stream of semi-lean aqueous amine solvent in such a manner that the exhaust stream and the solvent stream contact one another while flowing in opposite directions within the vessel. Hereinafter, the countercurrent flow section will be referred to as the “first flow section.”

“Cocurrent flow section” refers to a section of the absorber vessel which includes a second solvent distributor, a second solvent inlet, a second packing section, a gas outlet, a second liquid sump, a second level control valve, and a solvent pump fluidly connected to the second solvent outlet, and second liquid sump. The cocurrent flow section receives a stream of lean aqueous amine solvent in such a manner that the exhaust stream and the solvent stream contact one another while flowing in the same direction within the vessel. Hereinafter, the cocurrent flow section will be referred to as the “second flow section.”

In one or more embodiments disclosed is a compact absorber vessel design that greatly reduces system size and provides more dimensional flexibility for shipping or mobile operations. In one or more embodiments, disclosed is an absorber vessel significantly reduced in size, height, capital equipment costs, and associated costs in marine operations.

The techniques described herein provide for the contacting of a gas stream with a liquid stream. The gas stream will be substantially in the gas phase but may contain entrained liquid and/or solid materials. The liquid stream will be substantially in the liquid phase but may contain entrained gas and/or solid materials. The term “substantially” means greater than 90 wt %.

The techniques described herein provide for the absorption of carbon dioxide into a solvent, using both a countercurrent flow pattern in the first flow section and a cocurrent flow pattern in the second flow section, in series, within one integrated vessel. The techniques described herein provide for the absorption of a carbon dioxide gas product into a liquid solvent using a vessel including both countercurrent flow and cocurrent flow patterns.

The first flow section is configured to contact the gas stream with the liquid stream causing the liquid stream to absorb the carbon dioxide, by flowing the liquid stream in the opposite direction as the gas stream, against a packing section. The transfer of carbon dioxide from the exhaust stream to the liquid solvent is carried out via the intimate contact of the downward-flowing liquid phase, which forms a film on the packing section, and the upward-flowing vapor phase, allowing for efficient mass-transfer. The intimate contact of the downward-flowing liquid phase solvent may be enabled by the use of a solvent distributor including pipe distributors, pan distributors, spray nozzles, trough distributors, deck distributors, and/or rotating arm distributors. The packing section increases the surface area available for gas-liquid contact. The increased surface area provided by the packing section aids the reversible chemical absorption of carbon dioxide by an aqueous amine solvent.

The rapid chemical reaction of carbon dioxide absorption into the aqueous amine solvent is limited by liquid-film resistance. The reaction provides for a large increase in the mass-transfer coefficient which is directly proportional to the interfacial surface area of the packing section. Therefore, increasing the surface area in the packing section results in a corresponding mass-transfer increase. Chemical absorption of carbon dioxide into aqueous amine solvent is based on the reaction between carbon dioxide and amines and involves the following reaction mechanisms:

$$2 R - N {H}_{2} + C {O}_{2} ↔ R - N {H}_{3}^{+} + R - N H - C O {O}^{-}$$

$$R - N {H}_{2} + C {O}_{2} + {H}_{2} O ↔ R - N {H}_{3}^{+} + H C {O}_{3}^{-}$$

The packing section of the first flow section may include any type of structured packing. Structured packing includes an arrangement of fixed thin metal corrugated sheets stacked together and may be used to reduce pressure drop in the first flow section. In one or more embodiments, the structured packing may include metal sheets that are arranged vertically and parallel to the gas flow. In some embodiments, the angle formed between the corrugation channels and the incoming gas may be between 30 and 60 degrees, such as 30 and 40 degrees, 40 and 50 degrees, and 50 and 60 degrees.

In one or more embodiments, the sheets may be stacked in such a manner that each alternating sheet is flipped 180 degrees along a vertical axis of the column relative to the sheets on either side of it. In some embodiments, the corrugated sheets may be assembled into modules bearing a height of between 4 and 24 inches, each module stacked vertically in the packing section. In some embodiments, each module may be rotated 90 degrees along a horizontal axis relative to immediately adjacent modules stacked above and below. In one or more embodiments, the sheets may have dimples, ripples, holes, and other small-scale features designed to increase wetting, interfacial area, gas distribution, and liquid film mixing. The disclosed structured packing may have an overall geometric interfacial area of between 100 and 500, 500 and 1,000, 1,000 and 1,500, and 1,500 and 2,000 m²/m³. Finally, the disclosed structured packings may include structured packings commonly used for the absorption of CO₂ from flue gas, including but not limited to Mellapak Plus 252Y and Mellapak 250X manufactured by Sulzer.

As the pressure drop is related to column size, the first flow section containing structured packing typically operates below about 0.5 inH₂O/ft. As structured packing normally reaches a maximum capacity at a pressure drop of 1.22 inH₂O/ft, at a vapor velocity of 90 to 95% of the flooding velocity, this type of packing offers exceptional operational flexibility for the techniques disclosed herein. In one or more embodiments, the vapor velocity of between 60% and 90%, such as between 60% and 80%, of flooding velocity may be employed. Several possible reasons for limiting the vapor velocity to between 70% and 80% of flooding velocity may include minimizing the column diameter and allowing for efficient mass transfer.

The packing section of the first flow section may also include any type of bulk (random) packing. Bulk packing includes a plurality of singular solid elements, possibly identical in size, deposited in bulk within the packing section. The bulk packing may include Raschig rings, metal Pall rings, plastic Pall rings, Berl saddle, ceramic Intalox saddle, plastic Super Intalox saddle, and metal Intalox saddle. Pressure drop at the flooding limit may vary based on the gas velocity, bulk density, porosity, and the packing factor of the chosen bulk packing. In one or more embodiments, the pressure drop of the first flow section containing bulk packing may vary from between 0 and 30 inH₂O/ft, such as a lower limit of 0, 7, 10, 12, 15 to an upper limit of 15, 18, 20, 25, or 30 inH₂O/ft, where any lower limit can be combined with any mathematically compatible upper limit. In other embodiments, the packing section of the first flow section may also include any type of trays and other media sufficiently allowing for the mass-transfer of carbon dioxide from the exhaust stream to the liquid solvent.

The second flow section is configured to contact the gas stream with the liquid stream, thereby causing the liquid stream to absorb the carbon dioxide, by injecting the liquid stream into the exhaust gas stream as a fine mist of droplets over the packing in the second flow section. The mist may be delivered by a spray nozzle that is a full-cone spray nozzle selected to provide even liquid distribution across the packing. Additionally, a wide-angle cone including but not limited to an angle of 120 degrees may be used to minimize the height of the absorber by minimizing the distance between the nozzle tip and the top face of the packing. The mist provides absorption of the carbon dioxide into the liquid stream due to the high surface area of the second packing section. The surface area of the gas-liquid contact may be increased, and the residence time may be increased by cither fixed packing alone or by fixed packing with horizontal bubble trays. The packing section of the second flow section may include any type of structured packing that may also be used in the first flow section or any kind of random dense packing. The random dense packing may be packing that has a bulk density from between 1 and 50 lb/ft³, such as a lower limit of 1, 10, 20, 30, and 40 lb/ft³ to an upper limit of 10, 20, 30, 40, and 50 lb/ft³, where any lower limit can be combined with any mathematically compatible upper limit. Additionally, the random dense packing may be packing with a geometric interfacial area of between 100 and 500 m²/m³, such as a lower limit of 100, 150, 200, 250, 300, 350, 400, and 450 m²/m³, to an upper limit of 150, 200, 250, 300, 350, 400, 450, and 500 m²/m³, where any lower limit may be combined with any mathematically compatible upper limit. Finally, the random dense packing may be packing with a pressure drop of from between 0.01 and 41 inH₂O/ft, such as a lower limit of 0.01, 10, 20, and 30 inH₂O/ft, to an upper limit of 10, 20, 30, and 41 inH₂O/ft, where any lower limit can be combined with any mathematically compatible upper limit. A sweetened exhaust stream and a CO₂-enriched solvent stream may then be generated from the gas-liquid contact.

According to the embodiments described herein, the first flow section and second flow sections are in series, within the same absorber vessel. In one or more embodiments, the first flow section is upstream of the second flow section. Where the first flow section is upstream of the second flow section, further embodiments may include an additional flow section including an additional downstream first flow section. The series arrangement may include the following sequence: (1) a first flow section, (2) a second flow section, and (3) one or more first flow sections. Additionally, where the first flow section is upstream of the second flow section, further embodiments may include one or more additional second flow sections downstream of the initial second flow section. The series arrangement may include the following sequence: (1) a first flow section, (2) a second flow section, and (3) one or more second flow sections.

In one or more embodiments, the second flow section, the cocurrent flow section, is upstream of the first flow section, the countercurrent flow section. In one or more embodiments, a number of first and second flow sections may be employed in series to progressively purify the exhaust gas stream and remove progressively more carbon dioxide as the exhaust gas stream flows through the flow sections. In one or more embodiments, the configuration may include two first flow sections followed by two second flow sections. The series arrangement may include the following sequence: (1) a first flow section, (2) a first flow section, (3) a second flow section, and (4) a second flow section.

In one or more embodiments, the configuration may include a first flow section, followed by a second flow section, followed by first flow section, followed by a second flow section. The series arrangement may include the following sequence: (1) a first flow section, (2) a second flow section, (3) a first flow section, and (4) a second flow section. In one or more embodiments, the configuration may include two second flow sections in series, followed by two first sections. The series arrangement may include the following sequence: (1) a second flow section, (2) a second flow section, (3) a first flow section, and (4) a first flow section.

The “combustion engine exhaust gas stream” is the feed stream to be processed in the absorber vessel and may include the exhaust gas from a gasoline-fueled or diesel-fueled internal combustion engine. Hereinafter, “combustion engine exhaust gas stream” will be referred to as the “exhaust stream.” In one embodiment the exhaust stream may contain from about 3 to 13 mol % carbon dioxide (CO₂), about 3 to 13 mol % water vapor (H₂O), and the balance may contain nitrogen (N₂), oxygen (O₂), and other gases. The “other gases” may include but are not limited to sulfur dioxide (SO₂); oxides of nitrogen including but not limited to nitrogen dioxide (NO₂) and dinitrogen pentoxide (N₂O₅); hydrochloric acid (HCl); hydrofluoric acid (HF); and particulate matter including but not limited to soot and ash. In one or more embodiments, the exhaust stream may contain between 0 and 20 mol % carbon dioxide, such as a lower limit of 0, 5, 10, and 15 mol % carbon dioxide, to an upper limit of 5, 10, 15, and 20 mol %, where any lower limit can be combined with any mathematically compatible upper limit. The exhaust stream may contain between 1 and 99 mol % nitrogen, such as a lower limit of 1, 10, 20, 30, 40, 50, 60, 70, 80, 90 mol % nitrogen, to an upper limit of 10, 20, 30, 40, 50, 60, 70, 80, 90, and 99 mol %, where any lower limit can be combined with any mathematically compatible upper limit. The exhaust stream may contain between 0 and 99 mol % of oxygen and other gases, such as a lower limit of 0, 10, 20, 30, 40, 50, 60, 70, 80, 90 mol % to an upper limit of 10, 20, 30, 40, 50, 60, 70, 80, 90, and 99 mol %, where any lower limit can be combined with any mathematically compatible upper limit.

In one or more embodiments, the exhaust stream will be processed in the absorber vessel and fed first to the first flow section, producing a partially sweetened exhaust stream, which may then successively be fed into the second flow section to produce fully sweetened exhaust stream. The term “fully sweetened” stream does not necessarily equate to 0% carbon dioxide, but the fully sweetened exhaust stream will have a lower carbon dioxide concentration than the partially sweetened exhaust stream being recovered from the first flow section. Likewise, the “partially sweetened exhaust stream” has less carbon dioxide than the exhaust stream feed and more than the fully sweetened exhaust stream. In one embodiment, the exhaust stream may have between about 3 and 13 mol % CO₂, the partially sweetened exhaust stream may have between 0.74 and 12.4 mol % CO₂, and the fully sweetened exhaust stream may have between 0.04 and 11.9 mol % CO₂. In other embodiments, the exhaust stream may have between 0 and 20 mol % CO₂ and the partially sweetened exhaust stream may have between 0 and 19 mol % CO₂. In other embodiments, the fully sweetened exhaust stream may have between 0 and 18 mol % CO₂. Finally, the partially sweetened exhaust stream may have a CO₂ composition of between 5 and 95 mol % of the CO₂ composition of the upstream exhaust stream, such as a lower limit of 5, 10, 20, 30, 40, 50, 60, 70, 80, and 90 mol %, to an upper limit of 10, 20, 30, 40, 50, 60, 70, 80, 90, and 95 mol %, where any lower limit can be combined with any mathematically compatible upper limit. The fully sweetened exhaust stream may have a CO₂ composition of between 5 and 95 mol % of the CO₂ composition of the upstream partially sweetened exhaust stream, such as a lower limit of 5, 10, 20, 30, 40, 50, 60, 70, 80, and 90 mol %, to an upper limit of 10, 20, 30, 40, 50, 60, 70, 80, 90, and 95 mol %, where any lower limit can be combined with any mathematically compatible upper limit.

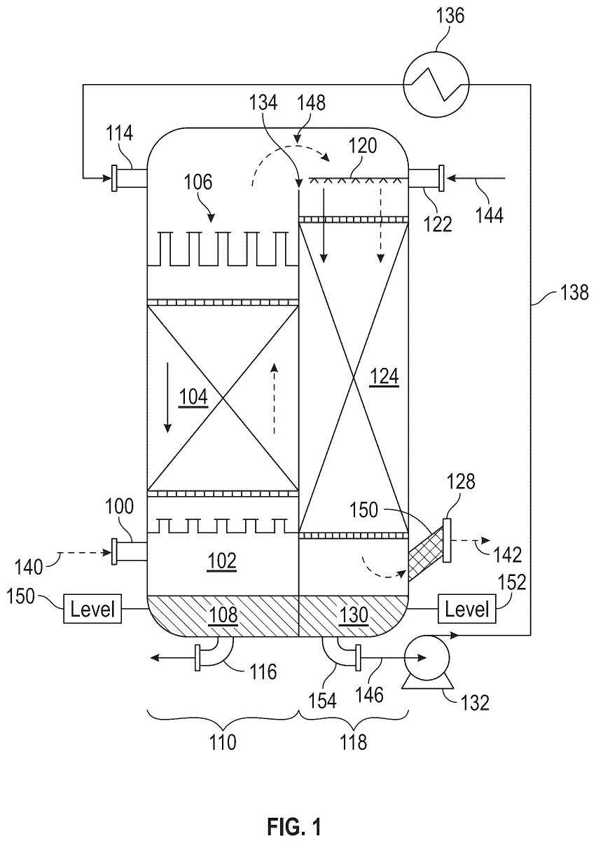

Turning now to the figures, FIG. 1 is a diagram of an absorber vessel having a first flow section and a second flow section divided by a divider 134 wherein the sections are volumetrically common and equalized in static pressure. At the bottom of the flow sections is a liquid sump that is separated in each section but fluidly connected. The absorber vessel receives an exhaust stream 140, through a gas inlet 100 just below the gas distributor 102 of the first flow section 110. The exhaust stream 140 is evenly distributed through a gas distributor 102 in order to standardize the velocity profile of the rising gas over the entire lower section of the packing section 104. The exhaust stream 140 is contacted with a semi-lean aqueous amine solvent in a fixed bed of packing, including a packing section 104.

A semi-lean aqueous amine solvent 146 is introduced at the top of the first flow section 110 at the solvent inlet 114 fluidly connected to a solvent distributor 106. The semi-lean aqueous amine solvent 146 produced from the second flow section 118, which receives and utilizes lean solvent 144 from a source not featured in the figure to absorb carbon dioxide. In addition to CO₂ absorption as described in this disclosure, solvent regeneration, CO₂ compression, CO₂ dehydration, and CO₂ storage or delivery are important to the overall processing and logistics of CO₂. Although not shown in FIG. 1, solvent regeneration may be by heating solvent and releasing CO₂, thereby regenerating lean solvent from CO₂-enriched solvent. Solvent regeneration may be performed by utilizing any type of heat including but not limited to waste heat from other sources in an associated manufacturing process.

The solvents suitable for both the semi-lean aqueous amine solvent 146 and the lean aqueous amine solvent 144 may be a liquid mixture having at least 10 wt % of an organic amine or alkali metal salt with a molecular weight of less than 200 g/mol. For example, this may include but is not necessarily limited to any aqueous or non-aqueous liquid amine solvent, including any derivative of amine, monoethanolamine (MEA), piperazine (PZ) and derivatives of PZ, methyldiethanolamine (MDEA), diethanolamine (DEA), and 2-amino-2-methyl propanol (AMP), and any combinations thereof. Suitable solvents may also include but are not limited to water, ethylene glycol, diethylene glycol, triethyleneglycol, tetraethyleneglycol, substituted pyrrolidones, and substituted imidazoles, sulfolane, and any combinations thereof. The concentration of the amine in the solvent may range from between 10 to 99 wt %.

The semi-lean aqueous amine solvent is injected at the top of the first flow section 110 and flows in a direction countercurrent to the exhaust stream in order to allow for mass transfer across the packing section 104. In order to have all the surface developed by the internal transfer, the solvent flow is distributed evenly over the entire packing section 104. For this reason, the semi-lean aqueous amine solvent is injected uniformly onto the packing section 104 and evenly distributed in a solvent distributor 106, and the exhaust stream is evenly distributed via a gas distributor 102. In one or more embodiments, the solvent distributor 106 may include pipe distributors, pan distributors, spray nozzles, trough distributors, deck distributors, and/or rotating arm distributors.

The transfer of carbon dioxide from the exhaust stream to the liquid solvent is carried out within the packing section 104. The packing section 104, which may include solid elements having a high contact area, allows for the liquid to be uniformly distributed and flow downward under gravity. The downward flowing liquid will contact the rising exhaust gas vapor, and thus enables efficient transfer of the material between the fluids. The packing section 104 may include bulk (random) packing or any type of structured packing.

Structured packing includes an arrangement of fixed metal sheets and may be used to reduce pressure drop in the first flow section 110 and the packing section 104. As the exhaust stream 140 rises through the packing section 104 gradually increasing amounts of carbon dioxide are removed from the stream by the semi-lean aqueous amine solvent. As the exhaust gas flows up to the vapor space of the first flow section, the exhaust stream will be a partially sweetened exhaust stream 148 and will have a lower relative concentration of carbon dioxide compared to the exhaust stream 140 that entered the first flow section at gas inlet 100.

As semi-lean aqueous amine solvent flows from the solvent inlet 114, the semi-lean aqueous amine solvent will collect at the base of the first flow section 110 in the liquid sump 108. The liquid sump is fluidly disconnected from the second liquid sump 130 and flows out through the solvent outlet 116. The solvent that collects in the in the liquid sump 108 will be rich aqueous amine solvent. The level in the liquid sump 108 is controlled by the level control valve 150. Although not shown in FIG. 1, the rich aqueous amine solvent may be pumped out of the liquid sump 108 and regenerated in a separate solvent regeneration system by heating the solvent to release the CO₂.

The partially sweetened exhaust stream 148 may be collected in the vapor space of the first flow section 110 and fed through a channel between the divider 134 and the top of the vessel and into the second flow section 118. The partially sweetened exhaust stream 148 is contacted with lean aqueous amine solvent 144, injected through a solvent inlet 122.

A lean aqueous amine solvent 144 is introduced at the top of the second flow section 118 at the second solvent inlet 122. The lean aqueous amine solvent 144 is evenly distributed across a second solvent distributor 120, that distributes the liquid homogenously onto the second packing section 124 and simultaneously contacts the partially sweetened exhaust stream 148 to be further sweetened as the liquid-gas mixture moves progressively vertically downwards through the second packing bed 124. Alternatively, the second solvent distributor 120 may spray the lean aqueous amine solvent 144 at a higher pressure than the absorber vessel through a spray nozzle. The second solvent distributor 120 may include a plurality of nozzles that allow for a reduced vertical distance spanning between above the second solvent distributor 120 and the top of the second flow section 118. The second packing section 124 may include any type of structured packing or bulk packing. The bulk packing used in the second packing section 124 may include a random dense packing or a loose packing. The random dense packing may be packing that provides for a bulk density of between 1 and 50 lb/ft³, a geometric interfacial area of between 100 and 500 m²/m³, and a pressure drop of between 0.01 and 41 inH₂O/ft. The second flow section 118 has low pressure drop and the gas velocity is not limited by column flooding. The second packing section 124, including either loose packing or random dense packing, may provide desired mixing and exposed surface area to promote the capture of the carbon dioxide in the exhaust stream by the lean aqueous amine solvent 144.

Optionally, a plurality of horizontal trays with liquid holes, may be installed in the second flow section, together with the packing in the second packing section 124 in order to increase the gas-liquid contact surface area and increase turbulence in the flow pattern. Optionally, horizontal trays with liquid holes may be installed in addition to the presence of the packing in the second packing section 124.

The lean aqueous amine solvent 144 may be solvent that has been regenerated in a separate solvent regeneration system not shown in FIG. 1. As the lean aqueous amine solvent 144 travels down through the second flow section 118, through either the second packing section 124 alone or the second packing section 124 with horizontal trays, the lean aqueous amine solvent 144 will become progressively more saturated with carbon dioxide and transition into semi-lean aqueous amine solvent. The semi-lean aqueous amine solvent will then collect in the liquid sump 130. The level height of the CO₂-enriched aqueous amine solvent will then be controlled by a controller of a solvent pump 132, which is controlled by the indication on the second level control valve 152.

In one or more embodiments, the second liquid sump 130, will be fluidly disconnected from the liquid sump 108. Alternatively, in one or more embodiments, the second liquid sump 130 and the liquid sump 108 may be fluidly connected, such that the semi-lean aqueous amine solvent 146 and the rich aqueous amine solvent are mixed. Additionally, instead of the level indication of both level control valve 150 and second level control valve 152, a single level indication the mixture of the rich aqueous amine solvent and the semi-lean aqueous amine solvent 146 may be used to control the solvent pump 132. This may cause the flow rate of the lean aqueous amine solvent 144 stream to increase to make up for flowing more saturated semi-lean aqueous amine solvent to the first flow section 110.

In the one or more embodiments wherein the second liquid sump 130 and the liquid sump 108 are exclusive and not in fluid communication, the collected semi-lean aqueous amine solvent 146 will be pumped out via a solvent pump 132 connected to a second solvent outlet 154. The semi-lean solvent line 138 will carry the discharge of the solvent pump 132 through a downstream heat exchanger 136. The downstream heat exchanger 136 will then cool the stream prior to feeding the stream to the top of the first flow section 110 through the solvent inlet 114, and successfully to the solvent distributor 106. The purpose of the heat exchanger is to provide interstage cooling to the semi-lean aqueous amine solvent 146, to remove the heat of absorption, and to improve the absorber performance by providing more mass transfer driving force.

As the partially sweetened exhaust stream 148 travels down the second flow section 118, and becomes entrained in the lean aqueous amine solvent, the partially sweetened exhaust stream 148 will gradually offload carbon dioxide and transition to a fully sweetened exhaust stream 142 and be received by a gas outlet 128. In one or more embodiments, the gas outlet 128 will be disposed an acute angle to the vertical wall of the second flow section. The acute angle of the gas outlet 128 may be disposed at an elevation above an obtuse angle to the vertical wall of the second flow section. The gas outlet may include a demister 150, which will be disposed at an acute angle to the vertical wall of the second flow section and comprise of fine packing to eliminate solvent mist and entrainment in gas outlet. The acute angle of the demister 150 may be disposed at an elevation above the obtuse angle to the vertical wall of the second flow section. Although not shown in FIG. 1, in some embodiments, gas outlet 128 may be disposed at an angle of 90 degrees to the vertical wall of the second flow section and the demister 150 may be disposed in a totally vertical orientation. While a couple of examples have been given, other arrangements of the gas outlet and demister are contemplated herein such that the demister 150 is to provide for vapor-liquid separation step further separating any remaining lean aqueous amine solvent 144 from the fully sweetened exhaust stream 142.

The flow rates of lean aqueous amine solvent 144 and semi-lean aqueous amine solvent 146 and exhaust gas feed 140, and temperatures and pressures should be controlled and the packing should be designed with a geometric interfacial area of greater than 100 m²/m³, such that cumulatively the second flow section and the first flow sections cumulatively achieve up to 90% capture rate.

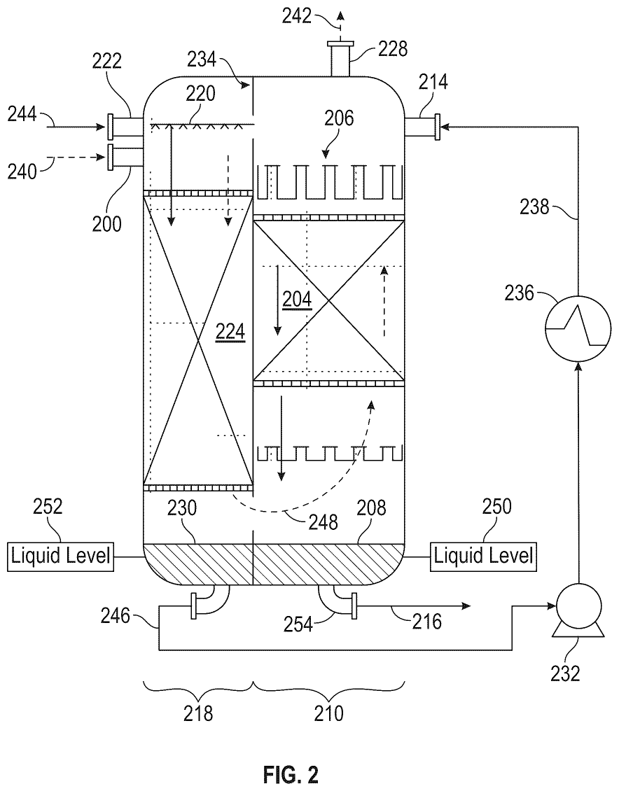

The sequence of first flow section followed by the second flow section as illustrated in FIG. 1 may be reversed to optimize the absorber efficiency for different applications. For example, FIG. 2 is a diagram of an absorber vessel including a first flow section and a second flow section divided by a divider 234 wherein the sections are volumetrically common and equalized in static pressure. At the bottom of the flow sections is a liquid sump that is separated in each section but fluidly connected. The divider 234 divides the packing sections and the liquid sumps of the two sections. Between the first and second flow sections is a channel that allows the partially sweetened exhaust stream 248 to travel. The absorber vessel receives the exhaust stream 240 through a gas inlet 200 located below the second liquid distributor 220 of the second flow section 218.

A lean aqueous amine solvent 244 is introduced at the top of the second flow section 118 at the second solvent inlet 222. The second solvent distributor 220 distributes the lean aqueous amine solvent 244, which is injected via second solvent inlet 222.

The solvents suitable for the lean aqueous amine solvent 244 may be a liquid mixture comprising at least 10 wt % of an organic amine or alkali metal salt with a molecular weight of less than 200 g/mol. For example, this may include but is not necessarily limited to any aqueous amine solvent or non-aqueous liquid amine solvent, including any derivative of amine, monoethanolamine (MEA), piperazine (PZ) and derivatives of PZ, and methyldiethanolamine (MDEA), diethanolamine (DEA), and 2-amino-2-methyl propanol (AMP), and any combinations thereof. Suitable solvents may also include but are not limited to water, ethylene glycol, diethylene glycol, triethyleneglycol, tetraethyleneglycol, substituted pyrrolidones, and substituted imidazoles, sulfolane, and any combinations thereof. The concentration of the amine in the solvent may range from around 10 to 99 wt %.

The lean aqueous amine solvent 244 is evenly distributed across a second solvent distributor 220, that distributes the liquid homogenously onto the second packing section 224 and simultaneously entrains the exhaust stream 240 to be sweetened as the liquid-gas mixture moves progressively vertically downwards through the second packing section 224. Alternatively, the second solvent distributor 220 may spray the lean aqueous amine solvent 244 at a higher pressure than the vessel. The second solvent distributor 220 may be comprised of nozzles that allow for a reduced vertical distance spanning between above the second solvent distributor 220 and the top of the second flow section 218. Similar to FIG. 1, the second packing section 224 may include any type of structured packing or bulk packing. The bulk packing used in the second packing section 124 may include a random dense packing or a loose packing. The random dense packing is packing that provides for a bulk density of between 1 and 50 lb/ft³, a geometric interfacial area of between 100 and 500 m²/m³, and a pressure drop of between 0.01 and 41 inH₂O/ft. The second flow section 218 has low pressure drop and the gas velocity is not limited by column flooding. The second packing section 224, including either loose or random dense packing, may provide desired mixing and exposed surface area to promote the capture of the carbon dioxide in the exhaust stream by the lean aqueous amine solvent 244.

Optionally, horizontal trays with liquid holes may be installed in the second flow section, together with the packing in the second packing section 224. Further, optionally horizontal trays with liquid holes may be installed in addition to the presence of the packing in the second packing section 224.

The lean aqueous amine solvent 244 may be solvent that has been regenerated in a separate system not shown in FIG. 2. As the lean aqueous amine solvent 244 travels down through the second flow section 218, through optionally either the second packing section 224 alone, or the second packing section 224 with horizontal trays, the lean aqueous amine solvent 244 will become progressively more saturated with carbon dioxide and transition into semi-lean aqueous amine solvent. The semi-lean aqueous amine solvent will then collect in the liquid sump 230. The level height of the CO₂-enriched aqueous amine solvent will then be controlled by a controller of a solvent pump 232, which is controlled by the indication on the second level control valve 252. In one or more embodiments, the second liquid sump 230, will be fluidly disconnected from the liquid sump 208. In one or more embodiments, the second liquid sump 230 and the liquid sump 208 may be fluidly connected, such that the semi-lean aqueous amine solvent 246 and the rich aqueous amine solvent 216 are mixed. Additionally, instead of the level indication of both level control 250 and second level control valve 152, a single level control indication may be used to control the solvent pump 232. This may cause the flow rate of the lean aqueous amine solvent 244 to increase to make up for flowing more saturated semi-lean aqueous amine solvent to the first flow section 210.

In the one or more embodiments wherein the second liquid sump 230 and the liquid sump 208 are exclusive of one another, the collected semi-lean aqueous amine solvent 246 will be pumped out via a solvent pump 232 connected to a second solvent outlet 254. The semi-lean solvent line 238 will then carry the discharge of the solvent pump 232 through a downstream heat exchanger 236. The downstream heat exchanger 236 will then cool the stream prior to feeding the stream to the top of the previously mentioned first flow section 210, through the solvent inlet 214, and successfully to the solvent distributor 206. The purpose of the heat exchanger is to provide interstage cooling to the semi-lean solvent to remove the heat of absorption and to improve the absorber performance by providing more mass transfer driving force.

As the exhaust 240 travels down the second flow section 218, due to entrainment and driving force pressure, the exhaust stream 140 will gradually offload carbon dioxide and transition to a partially sweetened exhaust stream 248 and travel through a channel between the second and first flow sections to first flow section 210. As the partially sweetened exhaust stream 248 rises gas over the packing section 204 the partially sweetened exhaust stream 248 is contacted with semi-lean aqueous amine solvent 246 in a fixed bed of packing, including a packing section 204. The semi-lean aqueous amine solvent 246 is injected at the top of the first flow section 210 via solvent inlet 214 and flows in a direction countercurrent to the exhaust stream to allow for mass transfer across the packing section 204. In order to have all the surface developed by the internal transfer, the 246 semi-lean aqueous amine solvent flow is distributed evenly through a solvent distributor 206 over the entire packing section 204.

The transfer of carbon dioxide from the exhaust gas to the liquid solvent is carried out within the packing section 204. The packing section 204, which may include solid elements having a high contact area, allows for the liquid to be uniformly distributed and flow downward under gravity. The downward flowing liquid will contact the rising exhaust gas vapor, and thus enables efficient transfer of the material between the fluids. The packing section 204 may include bulk packing or any type of structured packing.

Structured packing may be used in the first flow section 210 and the packing section 204. As the exhaust stream 240 rises through the packing section 204 gradually increasing amounts of carbon dioxide are removed from the stream by the semi-lean aqueous amine solvent. As the exhaust stream flows up to the vapor space of the first flow section, the exhaust stream will become a fully sweetened exhaust stream 242 and will have a lower relative concentration of carbon dioxide compared to the exhaust stream 248 that entered the packing section at the bottom of the first flow section 210.

As semi-lean liquid aqueous amine solvent flows from the solvent inlet 214, the semi-lean aqueous amine solvent will collect at the base of the first flow section 210, in the liquid sump 208. The liquid sump 208 is fluidly disconnected from the second liquid sump 230 and flows out through the solvent outlet 216. The solvent that collects in the in the liquid sump 208 will be rich aqueous amine solvent. The level in the liquid sump 208 is controlled by level control valve 252. Although not shown in FIG. 2, the rich aqueous amine solvent may be pumped out of the liquid sump 208 and regenerated in a separate solvent regeneration system by heating the solvent to release the CO₂.

In one or more embodiments, the second liquid sump 230 and the concurrent liquid sump 208 may be fluidly connected, such that the semi-lean aqueous amine solvent 246 and the rich aqueous amine solvent are mixed. Additionally, instead of level indication of both level control valve 250 and second level control valve 252, a single level control indication may be utilized to control the solvent pump 232. This may cause the flow rate of the lean aqueous amine solvent 244 stream to increase to make up for flowing more saturated semi-lean aqueous amine solvent to the first flow section 210.

The gas outlet 228 will be located at the very top of the first flow section through a liquid disengagement zone to ensure any entrained semi-lean aqueous amine solvent 246 is no longer entrained, and the partially sweetened exhaust stream 248 has been transitioned into a fully sweetened exhaust stream 242.

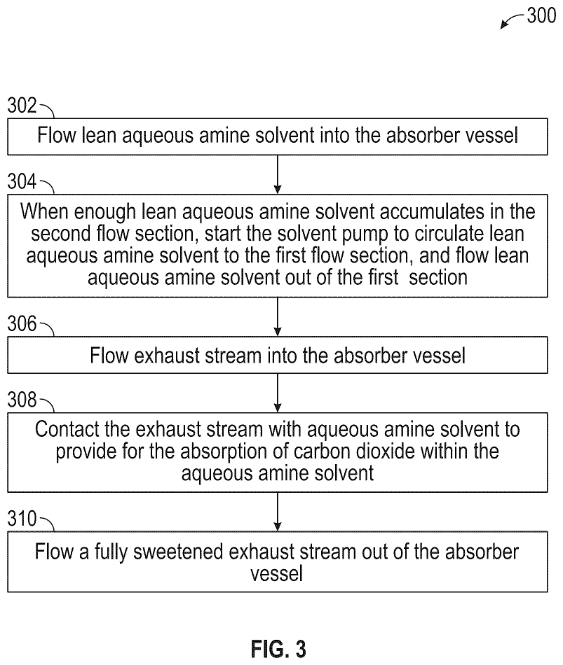

FIG. 3 illustrates a method 300 of reducing emissions from the exhaust gas of a combustion engine by contacting the exhaust gas with aqueous amine solvent in an absorber vessel. The method 300 may be implemented within a system for reducing emissions from a combustion engine comprising a first flow section and a second flow section. The method 300 may be implemented by one or more first flow sections, one or more second flow sections, and any of the configurations illustrated in FIG. 1 and FIG. 2.

The method begins at step 302, in which the solvent delivery system is utilized to initiate solvent circulation. In step 302, a lean aqueous amine solvent is flowed into the absorber vessel. In step 304, when enough aqueous amine solvent has accumulated in the second flow section, the solvent pump connected to the second flow section may be started to initiate solvent circulation to the first flow section of the absorber vessel, where solvent can then be flowed out of the second flow section. This will ensure that before the exhaust stream is added to the system of FIG. 1 or FIG. 2, the lean aqueous amine solvent is in circulation. In step 306, an exhaust stream containing carbon dioxide flows into the absorber vessel, and first into the first flow section or first into the second flow section, depending on the embodiment.

In step 308, the exhaust stream is contacted with aqueous amine solvent to provide for the absorption of carbon dioxide within the aqueous amine solvent. If the exhaust stream is flowing first into the first flow section, the exhaust gas stream will evenly distribute through a gas distributor in a countercurrent pattern to the semi-lean aqueous amine solvent, providing for gas-liquid contact. If the exhaust stream is flowing first into the second flow section, the exhaust stream will be entrained by a semi-lean aqueous amine solvent distributed across a solvent distributor, providing for gas-liquid contact. In the first flow section, rich aqueous amine solvent is collected in the liquid sump. In the second flow section, a semi-lean aqueous amine solvent is collected in the second liquid sump, which is connected to the solvent delivery system, which provides for a solvent pump pumping semi-lean aqueous amine solvent from the second liquid sump to the top of the first flow section disposed within the semi-lean solvent line. In both the first flow section and the second flow section, the carbon dioxide content in the exhaust stream is decreasing throughout the gas-liquid contact and carbon dioxide absorption. In step 310, a fully sweetened exhaust stream is collected from the absorber vessel.

In both the configuration illustrated by FIG. 1 and the configuration illustrated by FIG. 2, the disclosure has the flexibility to add more sections as needed without increasing the height of the column due to the low pressure drop of the second flow section. Thus, a correspondingly lower volume and a smaller footprint is required as compared to an exclusively countercurrent arrangement. Finally, the disclosure also has the flexibility to add more sections in any three-dimensional direction including but not limited to vertical and horizontal directions.

The techniques described herein also reduce the height of the absorber vessel by providing for both a first flow section (countercurrent flow) and second flow section (cocurrent flow) integrated within one vessel rather than a conventional singular countercurrent flow column. The integration allows for the increase of the exhaust gas travel distance without a change to the external height of the absorber vessel. Additionally, the integration of the multiple flow sections within one vessel allows for reduced material costs and fabrication costs through the effect of shared walls between the flow sections, fewer required pieces, and reduced quantity of welds. The packing in the second flow section may feasibly have very high surface area per volume because the pressure drop in the second flow section is low and there is no flooding limit. Because of this, adding the second flow section to a first flow section allows for a more compact vessel than a single countercurrent column.

In one or more embodiments, there may be multiple second flow sections in series following the initial second flow section. In one or more embodiments, one additional downstream second flow section may include a cocurrent water wash system for further removal of carbon dioxide and may follow the second flow section. Water-soluble gas such as carbon dioxide may dissolve into the water and the exhaust stream may be further sweetened. In one or more embodiments, the additional water wash second section may be mechanically integrated into the absorber vessel. The water wash system may provide for an exclusive water wash sump, an exclusive circulation pump, and an exclusive vapor space to prevent fluid communication between the aqueous amine solvent and water.

In one or more embodiments which includes the first flow section followed by the second flow section, the second flow section may be followed by an additional first flow section incorporated in the same absorber vessel. The configuration will be similar to FIG. 1, and the aqueous amine solvent utilized in the additional first flow section may either be the semi-lean aqueous amine solvent derived from the initial first flow section 146, the lean aqueous amine solvent 122, or combinations thereof, depending on operating parameters. The solvent selected used may be adjusted according to the operating target of up to 95% capture rate, depending on the application preferred. Achievement of a 95% capture rate may depend on equipment sizing factors such as height and diameter of the first and second flow sections and heat exchanger area. Additionally, operating parameters such as the solvent circulation rate, temperature, pressure, and lean solvent loading also affect the achievement of 95% capture rate. Adding further flow sections in series will increase the mass transfer without increasing the height of the absorber.

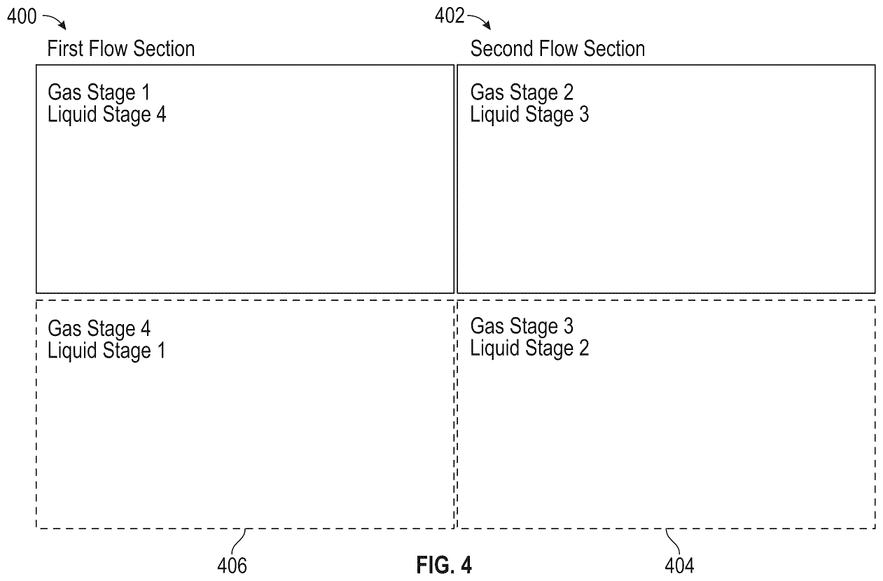

Generally, as more flow sections are added the capital cost will increase and the process will gain mass transfer. FIG. 4 illustrates a four-stage diagram where the exhaust stream and aqueous amine solvent liquid may flow through multiple first flow sections and multiple second flow sections within the absorber vessel. An exhaust stream first flows into section 400, and successively to section 402, section 404, and section 406. In a reverse sequence, the aqueous amine solvent flows from section 406, to section 404, section 402, and finally to section 400.

Embodiments of the disclosure provide for a column with reduced height because of the integration of first and second flow sections within one single vessel. The first flow section is the same as the conventional column with reduced height. The disclosure allows for changing the aspect ratio of the absorber without introducing the cost and complexity of using multiple absorbers in series and thus reduces capital cost and the need for vertical space on a vessel.

Unless defined otherwise, all technical and scientific terms used have the same meaning as commonly understood by one of ordinary skill in the art to which these systems, apparatuses, methods, processes and compositions belong.

The singular forms “a,” “an,” and “the” include plural referents, unless the context clearly dictates otherwise.

As used here and in the appended claims, the words “comprise,” “has,” and “include” and all grammatical variations thereof are each intended to have an open, non-limiting meaning that does not exclude additional elements or steps.

“Optionally” means that the subsequently described event or circumstances may or may not occur. The description includes instances where the event or circumstance occurs and instances where the event or circumstance does not occur.

When the word “approximately” or “about” are used, this term may mean that there can be a variance in value of up to +10%, of up to 5%, of up to 2%, of up to 1%, of up to 0.5%, of up to 0.1%, or up to 0.01%.

Ranges may be expressed as from about one particular value to about another particular value, inclusive. When such a range is expressed, the range is to be understood that another embodiment is from the one particular value to the other particular value, along with all particular values and combinations thereof within the range.

While the disclosure includes a limited number of embodiments, those skilled in the art, having benefit of this disclosure, will appreciate that other embodiments may be devised which do not depart from the scope of the present disclosure. Accordingly, the scope should be limited only by the attached claims.

What is claimed is:

1. An absorber vessel comprising:
a first flow section comprising:
a gas inlet,
a gas distributor disposed proximate a bottom of the first flow section and fluidly connected to the gas inlet,
a liquid sump disposed below the gas distributor,
a level control valve disposed below the gas distributor,
a packing section disposed above the gas distributor,
a solvent inlet,
a solvent distributor disposed proximate a top of the first flow section and fluidly connected to the solvent inlet, and
a solvent outlet fluidly connected to the liquid sump;
a second flow section comprising:
a second solvent inlet,
a second solvent distributor disposed proximate a top of the second flow section and fluidly connected to the second solvent inlet,
a second packing section disposed below the second solvent distributor,
a gas outlet,
a second liquid sump disposed below the second packing section,
a second level control valve disposed below the second packing section,
a second solvent outlet connected to the second liquid sump, and
a solvent pump fluidly connected to the second solvent outlet;
a divider that divides the first flow section and the second flow section; and
a vapor space configured for fluidly connecting the first flow section and the second flow section.

2. The absorber vessel of claim 1, wherein the liquid sump and the second liquid sump are fluidly connected.

3. The absorber vessel of claim 1, wherein the packing section comprises a structured packing and the second packing section comprises a random packing.

4. The absorber vessel of claim 1, wherein the second flow section includes a plurality of horizontal trays where each of the plurality of horizontal trays includes one or more liquid holes.

5. The absorber vessel of claim 1, further comprising a semi-lean solvent line fluidly connecting the second solvent outlet and the solvent inlet, a heat exchanger disposed in the semi-lean solvent line.

6. The absorber vessel of claim 1, wherein the second solvent distributor includes a plurality of nozzles.

7. The absorber vessel of claim 1, further comprising one or more first flow sections and one or more second flow sections.

8. A system for reducing emissions from a combustion engine, the system comprising:
a first flow section comprising:
an exhaust stream fluidly connected to a gas distributor, wherein the gas distributor is configured to provide the exhaust stream to the first flow section in an upwards direction;
a semi-lean aqueous amine solvent fluidly connected to a solvent distributor, a semi-lean aqueous amine solvent introduced to a top of the first flow section, where the semi-lean aqueous amine solvent is in countercurrent contact with the exhaust stream in a packing section disposed between the gas distributor and a solvent inlet, thereby producing a rich aqueous amine solvent and a partially sweetened exhaust stream; and
a liquid sump disposed below the gas distributor comprising a level control valve;
a second flow section further comprising:
a partially sweetened exhaust stream fluidly connected to the first flow section;
a lean aqueous amine solvent fluidly connected to a second solvent distributor, the lean aqueous amine solvent introduced to a top of the second flow section, where the lean aqueous amine solvent is in cocurrent contact with the partially sweetened exhaust stream in a second packing section disposed between the second solvent distributor and a gas outlet, thereby producing a semi-lean aqueous amine solvent and a fully sweetened exhaust stream configured to collect a fully sweetened exhaust stream; and
a second liquid sump disposed below the second packing section comprising a second level control valve disposed below the second packing section;
a solvent delivery system further comprising:
a semi-lean solvent line fluidly connecting the second liquid sump and the top of the first flow section;
a solvent pump configured for pumping the semi-lean aqueous amine solvent from the second liquid sump to the top of the first flow section disposed within the semi-lean solvent line; and
a heat exchanger configured for cooling the semi-lean aqueous amine solvent disposed within solvent line.

9. The system of claim 8, wherein the semi-lean aqueous amine solvent and the lean aqueous amine solvent comprises monoethanolamine, (MEA), piperazine (PZ), and methyldiethanolamine (MDEA), diethanolamine (DEA), 2-amino-2-methyl propanol (AMP), and any combination thereof.

10. The system of claim 8, wherein the semi-lean aqueous amine solvent and the lean aqueous amine solvent comprise a liquid mixture with at least 10 wt % of an organic amine or alkali metal salt with a molecular weight of less than 200 g/mol.

11. The system of claim 8, further comprising a controller configured for controlling a speed of the solvent pump based on a level of semi-lean aqueous amine solvent in the second liquid sump as measured by the second level control valve.

12. The system of claim 8, wherein the second packing section has a geometric interfacial area of greater than 100 m²/m³.

13. The system of claim 8, further comprising one or more first flow sections and one or more second flow sections, and wherein an exhaust stream flow path is provided through a first of the one or more first flow sections, a first of the one or more second flow sections, a second of the one or more first flow sections, and a second of the one or more second flow sections.

14. The system of claim 8, further comprising an additional second flow section, including a water wash section.

15. The system of claim 8, wherein the second flow section comprises both the second packing section and one or more horizontal trays with liquid holes.

16. The system of claim 8, wherein the packing section comprises a structured packing.

17. The system of claim 8, wherein the second packing section comprises a random packing.

18. A method of reducing emissions from a combustion engine, the method comprising:
flowing an exhaust stream into a bottom of a first flow section of an absorber vessel via a gas distributor and injecting a semi-lean aqueous amine solvent into a top of the first flow section via a solvent distributor:
contacting the exhaust stream with the semi-lean aqueous amine solvent in a packing section of the first flow section in countercurrent flow;
obtaining a partially sweetened exhaust stream having a reduced CO₂ concentration; and
generating a rich aqueous amine solvent and accumulating the rich aqueous amine solvent in a liquid sump;
flowing the partially sweetened exhaust stream into a top of a second flow section of the absorber vessel and injecting a lean aqueous amine solvent into the top of the second flow section via a second solvent distributor:
contacting the partially sweetened exhaust stream with the lean aqueous amine solvent in a second packing section of the second flow section in cocurrent flow;
obtaining a fully sweetened exhaust stream having a CO₂ concentration less than the partially sweetened exhaust stream from the second flow section; and
generating the semi-lean aqueous amine solvent accumulating the semi-lean aqueous amine solvent in a second liquid sump;
pumping the semi-lean aqueous amine solvent from the second liquid sump to the top of the first flow section; and
cooling the semi-lean aqueous amine solvent via a heat exchanger prior to injection into the first flow section.

19. The method of claim 18, further comprising pumping the semi-lean aqueous amine solvent from the second liquid sump and the rich aqueous amine solvent from the liquid sump to the top of the first flow section.

20. The method of claim 18, wherein the first flow section comprises one or more first flow sections and the second flow section comprises one or more second flow sections, further comprising flowing the exhaust stream through a first of the one or more first flow sections, a first of the one or more second flow sections, a second of the one or more first flow sections, and a second of the one or more second flow sections.

21. The method of claim 18, further comprising contacting the lean aqueous amine solvent with the partially sweetened exhaust stream across the second packing section comprised of one or more horizontal trays, a plurality of horizontal trays.

22. The method of claim 18, further comprising contacting the semi-lean aqueous amine solvent with the exhaust stream in the packing section comprised of structured packing.

23. The method of claim 18, further comprising contacting the lean aqueous amine solvent with the partially sweetened exhaust stream in the second packing section comprised of random packing.
